(19) United States
(12) Patent Application Publication
(10) Pub. No.: US 2015/0369271 A1
(43) Pub. Date: Dec. 24, 2015

(54) Fastener

(71) Applicants: AIRBUS OPERATIONS LIMITED, Filton, Bristol (GB); AIRBUS OPERATIONS GMBH, Hamburg (DE)

(72) Inventors: Domenico FURFARI, HAMBURG (DE); Roman STARIKOV, HAMBURG (DE); John STUCKEY, Bristol (GB); Jianhong LIN, Bristol (GB)

(21) Appl. No.: 14/764,862

(22) PCT Filed: Jan. 30, 2014
(86) PCT No.: PCT/GB2014/050247

§ 371 Date: Jul. 30, 2015

(30) Foreign Application Priority Data
Jan. 31, 2013 (GB) 1301772.8

(51) Int. Cl. F16B 19/06; B64C 3/26; B64C 1/12

(52) U.S. Cl. CPC F16B 19/06; B64C 1/12; B64C 3/26

(57) ABSTRACT

A fastener comprising a shaft having a first end and a second end, the fastener comprising a head at a first end of the shaft, the shaft defining either a radially extending recess between the first and second ends and/or a head with regions having different radii of curvature.

The present invention is concerned with a fastener. More specifically, the present invention is concerned with a mechanical fastener for attaching adjacent, parallel composite panel sections in an aircraft structure.

Fuselage and wing structures of commercial and military aircraft can be built from sheet composite components joined with fasteners. The panels are overlapped and a fastener passed through aligned bores in the components. Such fasteners generally comprise a shaft terminating in a head. At the opposite end of the shaft to the head there is provided a threaded portion. Once the fastener has been passed through both panels such that the head abuts one panel, the nut is engaged with the thread to clamp the panels together. The fastener is usually subjected to a tensile preload introduced during the tightening process.

Some fasteners may be countersunk—that is a recess may be provided in one panel around the bore to receive the head, such that the top of the head is flush with the panel. This makes a more compact and aesthetically pleasing assembly.

In an aircraft environment, there is a significant amount of load that is transferred through the panels via the fasteners. Vibration and expansion and contraction of components due to temperature variations during the flight are typical environmental conditions to which an aircraft structure is subjected. As such, one of the most common failure modes of mechanical fasteners is fatigue. In order to minimise fatigue damage, and thereby extend service intervals, fasteners are generally designed in order to minimise the peak stresses thereon when subjected to known load cases representing in-service use of fastened structures

It is desirable to subject fasteners joining two adjacent panel sections to a high axial tensile load (i.e. a tensile pre-load), to encourage frictional forces between the panels to retain them in position. Loads to be passed between the panels will then be transferred through friction rather than via the bearing load (i.e. fastener shear).

A problem with fastening composite panels in this environment is that the composite material adjacent the fastener can wear with repeated cycling (which does not tend to occur as quickly with metallic materials). The preload can thereby be reduced, allowing more relative panel movement and exacerbating the problem. Hole clearages can develop which may result in point loads on the fastener, and in the fastener being placed in bending within the panel bores.

Despite the aforementioned advantages of countersunk fasteners, it is known that countersunk joining is generally weaker than traditional joining with protruding head fasteners.

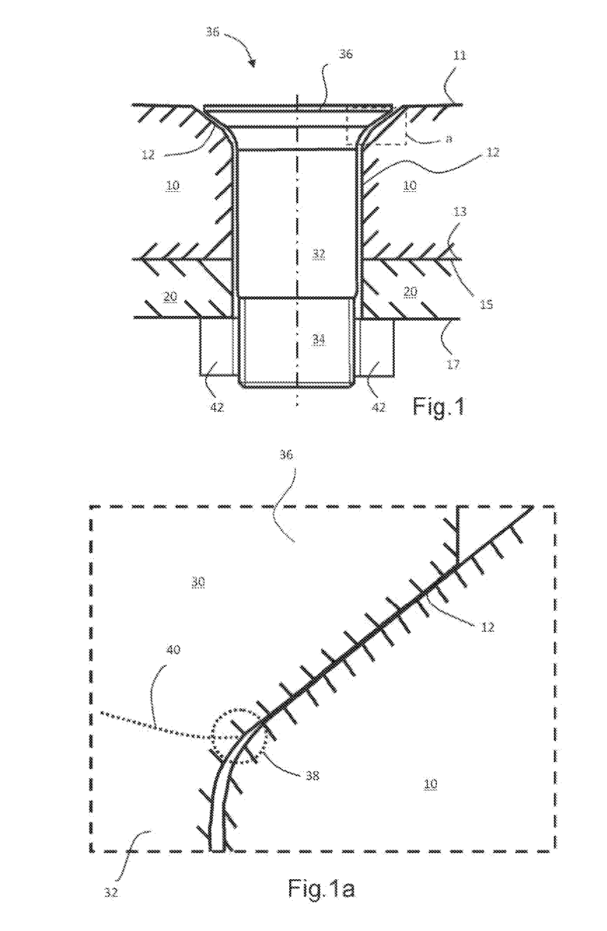

Turning to FIG. 1 of the appended drawings, a first panel 10 having a first surface 11 and a second surface 13. The first panel is constructed from a composite material. A second panel 20 has a first surface 15 and a second surface 17. The panels 10, 20 are joined by a known countersunk fastener 30. The fastener 30 comprises a shaft 32 having a threaded portion 34 at one end and a head 36 at a second end which engages with a countersunk bore 12 in the first panel 10. A nut 42 is threaded onto the threaded portion 34 to clamp the panels 10, 22 between the head 36 and the nut 42.

Turning to FIG. 1a, the bore 12 has become worn over time and as such the fastener 30 has some freedom of movement within the bore 12. Due to this freedom of movement, the fastener 30 undergoes bending under load and as such peak stresses are experienced in the region 38 proximate where the head 36 meets the shaft 32. These peak stresses in the region 38 can result in fatigue failure, for example along a fault line 40.

It is an aim of the present invention to overcome or at least alleviate this problem.

According to a first aspect of the invention there is provided an aircraft structural panel fastener comprising a shaft having a first end and a second end, the fastener comprising a head at a first end of the shaft, the shaft defining a radially extending recess between the first and second ends. Preferably the fastener is installed in n aircraft assembly comprising:
a first panel having a first bore;
a second panel having a second bore aligned with the first bore;
in which at least one of the first and second panels is constructed from a composite material;
the fastener extending at least partially through the first and second bores.

The provision of a recess means that some additional elastic flexibility is provided within the shaft structure itself. This allows the head to flex relative to the shaft and, as such, the local plastic stresses are not as high at the contact point between the countersunk bore and the head itself. As such, if the first or second panel was to wear, the extra deformation of the fastener would not cause high stresses (the fastener would be less stiff).

The first and/or second panels may be constructed from a plastic matrix composite such as CFRP or GRP. The invention is particularly useful for polymer matrix composites as they wear quickly compared to metals.

Preferably the recess is closer to the first end than the second end. More preferably recess is proximate the first end. Even more preferably the recess has an axial length, and the recess is within two axial lengths of the first end.

Preferably the recess extends at least partially around the circumference of the shaft for multi-directional effect. Preferably the recess extends around the entire circumference of the shaft.

Preferably the recess has a curved cross-section to avoid stress concentrations. More preferably the recess has a radiussed cross-section. Even more preferably the recess is semicircular in cross-section.

Preferably the head has a concave, curved cross-section. More preferably the cross-section of the head has a first region with a first radius, and a second region with a second radius higher than the first, in which the second region is axially further from the shaft than the first region. Preferably the second region is longer than the first region.

According to a second aspect of the invention there is provided a fastener for an aircraft structure, the fastener comprising a shaft and a head, in which the bugle shaped head comprises:
a first region proximate the shaft, the first region having a first radius of curvature, and,
a second region on the opposite side of the first region to the shaft, the second region having a second radius of curvature,
in which the second radius of curvature is larger than the first radius of curvature.

The first and second aspects may be combined for additional effect.

Preferably the first region is adjacent the shaft.

In embodiments according to the first or second aspect, a tangent of the first region where it meets the shaft may be aligned with the shaft. The first and second regions may be adjacent.

The head may comprise an intermediate region joining the first and second regions, in which the intermediate region gradually increases in radius from the first radius to the second radius.

The intermediate region may describe an involute curve.

The second radius may be at least two times the first radius.

The second radius may terminate at an end edge of the fastener head.

Preferably the head comprises an end region between the second region and the end of the head opposite the shaft, the end region being curved oppositely to the first and second regions.

In an assembly of a panel and fastener according to the first or second aspect, the head may extend more than ⅔ of the thickness of the panel. The head may extend all the way through the thickness of the panel.

Preferably the head joins the shaft at the lower surface of the upper panel surface.

An example fastener in accordance with the present invention will now be described with reference to the following drawings in which:

FIG. 1 is a prior art fastener assembly;

FIG. 1a is a close-up view of the region ‘a’ of FIG. 1;

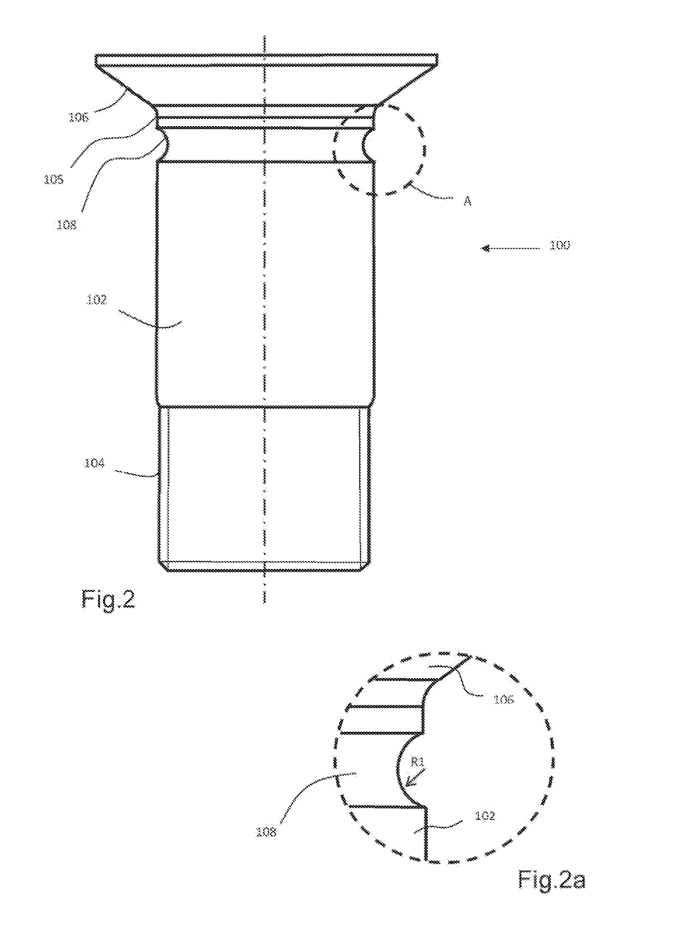

FIG. 2 is a side view of a fastener in accordance with the present invention;

FIG. 2a is a close-up view of the region ‘a’ of FIG. 2;

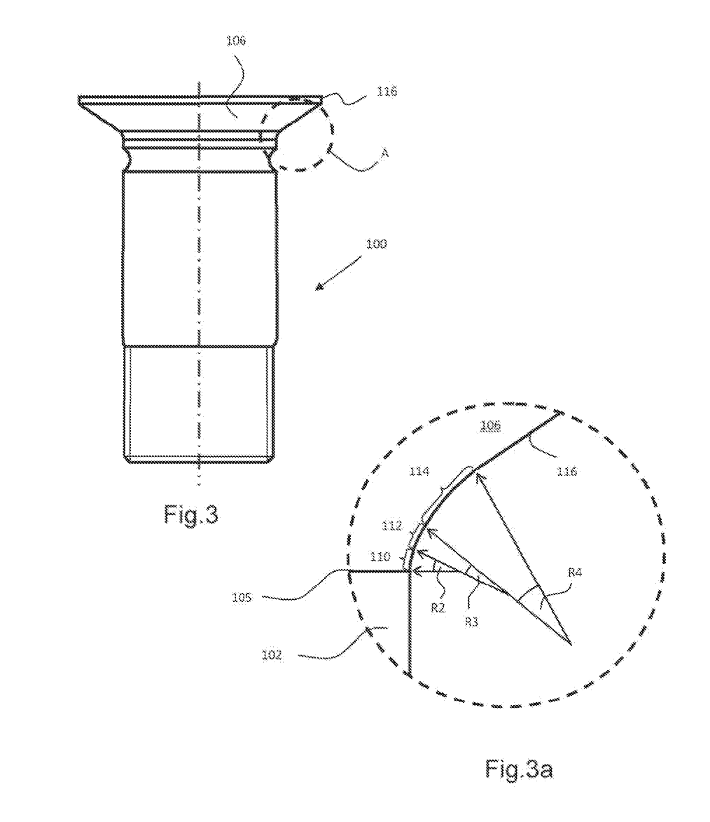

FIG. 3 is a view of the fastener of FIG. 2;

FIG. 3a is a close-up view of the region ‘a’ of FIG. 3;

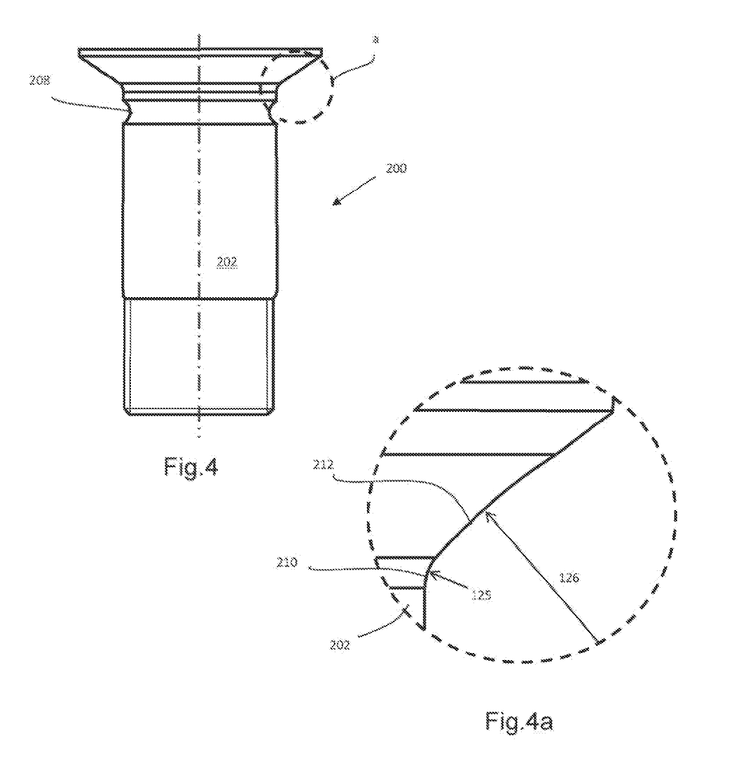

FIG. 4 is a side view of a further fastener in accordance with the present invention; and

FIG. 4a is a close-up view of the area ‘a’ of FIG. 4.

Turning to FIG. 2, the invention provides a fastener 100 which has a shaft 102 defining a threaded region 104 at one end thereof. At the opposite end of the threaded region 104 on the shaft 102, there is provided a countersunk head 106. The head is tapered and extends from an axial position 105 on the shaft 102. Position 105 is where the otherwise cylindrical shaft 102 starts to become larger in diameter to form the head 106.

Between the head 106 and the threaded portion 104, and proximate the position 105, there is defined a circumferential recess or notch 108 in the shaft 102. The recess 108, with reference to FIG. 2a, has a semi-circular radius cross section of radius R1 and extends all the way around the circumference of the shaft 102, as shown in FIG. 2.

The countersunk head 106 is shown in more detail in FIG. 3a.

Where the shaft 102 meets the head 106 at position 105, there is provided a first head portion 110 having a radius R2, a second head portion 112 having a second radius R3 and a third head portion 114 having a third radius R4. The radii R2, R3 and R4 increase until joining a cylindrical portion 116 of the head 106.

It will also be noted that the geometric length (i.e. the locus) of each of the sections 110, 112 and 114 increases moving away from the shaft 102.

An alternative fastener 200 is shown in FIG. 4 which is substantially identical to the fastener 100 with the exception that, and with reference to FIG. 4a, only a first radius portion 210 and a second radius portion 212 are provided, each having a distinct and different radius. It will be noted that the length of the section 212 is much longer than the section 210. Furthermore, the larger radius section 212 is further from the shaft 202 than the smaller radius section 210.

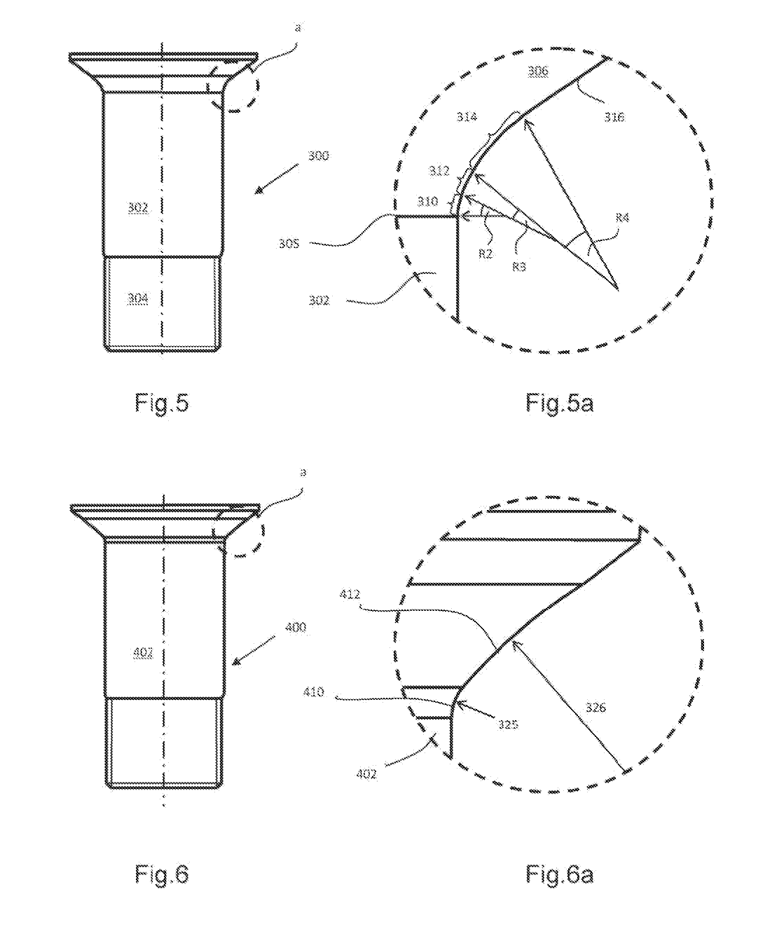

Turning to FIG. 5, the invention provides a fastener 300 which has a shaft 302 defining a threaded region 304 at one end thereof. At the opposite end of the threaded region 304 on the shaft 302, there is provided a countersunk head 306. The head is tapered and extends from an axial position 305 on the shaft 302. Position 305 is where the otherwise cylindrical shaft 302 starts to become larger in diameter to form the head 306.

The main difference between the fastener 100 and the fastener 300 is the absence of a notch 108 in the latter.

The countersunk head 106 is shown in more detail in FIG. 5a.

Where the shaft 302 meets the head 106 at position 305, there is provided a first head portion 310 having a radius R2, a second head portion 312 having a second radius R3 and a third head portion 314 having a third radius R4. The radii R2, R3 and R4 increase until joining a cylindrical portion 316 of the head 306.

An alternative fastener 400 is shown in FIG. 6 which is substantially identical to the fastener 300 with the exception that, and with reference to FIG. 6a, only a first radius portion 410 and a second radius portion 412 are provided, each having a distinct and different radius. It will be noted that the length of the section 412 is much longer than the section 410. Furthermore, the larger radius section 412 is further from the shaft 402 than the smaller radius section 410.

The provision of a head cross section having more than one region of differing radii allows for a better fit between the fastener and panel. Further, the provision of more than one radii allows for the head to have a small radius of curvature near the shaft and a larger radius of curvature distal from the shaft. This is advantageous because is reduces the “corner” or “knife edge” condition that would occur with a single large radius between the shaft and head for the same depth and diameter of head. Therefore the resulting stress concentration is mitigated.

The notch or recess 108, 208 provides the ability for the head 106 to move elastically in use. As such, as the bore surrounding the fastener 100, 200 opens up due to wear, the fastener 100, 200 can flex elastically. This flexion reduces the point loading upon the head and therefore significantly reduces the plastic stresses that are felt in this region. As such fatigue failure is mitigated.

It will be noted that variations fall within the scope of the present invention.

The countersink radius if curvature need not be made from several discrete sections, but may increase gradually moving away from the shaft.

The recess could be provided on a traditional straight-sided fastener without using curvature for the countersunk portion. The benefit of the recess would still be apparent.

The fastener does not have to be used to join composite panels and, indeed, any type of panel is suitable to be joined by the fastener of the present invention.

The invention may be used to join more than two panels. For example, the invention may be used in a double lap shear configuration, which comprises three panels joined together.

1. An aircraft assembly comprising:
a first panel having a first bore;
a second panel having a second bore aligned with the first bore;
in which at least one of the first and second panels is constructed from a composite material;
a fastener extending at least partially through the first and second bores, the fastener comprising:
a shaft having a first end and a second end;
a head at a first end of the shaft; and,
a radially extending recess between the first and second ends of the shaft.

2. An aircraft assembly according to claim 1 in which the recess is closer to the first end than the second end.

3-26. (canceled)

27. An aircraft assembly according to claim 2 in which the recess is proximate the first end.

28. An aircraft assembly according to claim 27 in which the recess has an axial length, and in which the recess is within two axial lengths of the first end.

29. An aircraft assembly according to claim 1 in which the recess extends at least partially around the circumference of the shaft, and preferably around the entire circumference of the shaft.

30. An aircraft assembly according to claim 1 in which the recess has a curved cross-section.

31. An aircraft assembly according to claim 30 in which the recess has a radiussed cross-section, preferably a semicircular cross-section.

32. An aircraft assembly according to claim 1 in which the head has a concave, curved cross-section.

33. An aircraft assembly according to claim 32 in which the concave, curved cross-section of the head has a first region with a first radius, and a second region with a second radius higher than the first, in which the second region is axially further from the shaft than the first region.

34. A fastener for an aircraft structure, the fastener comprising a shaft and a head, in which the head comprises:
a curved, concave cross section having:
a first region proximate the shaft, the first region having a first radius of curvature, and,
a second region on the opposite side of the first region to the shaft, the second region having a second radius of curvature,
in which the second radius of curvature is larger than the first radius of curvature.

35. A fastener according to claim 34, in which the first region is adjacent the shaft.

36. A fastener according to claim 35, in which a tangent of the first region where it meets the shaft is aligned with the shaft.

37. A fastener according to claim 34 in which the first and second regions are adjacent.

38. A fastener according to claim 34 in which the head comprises an intermediate region joining the first and second regions, in which the intermediate region gradually increases in radius from the first radius to the second radius.

39. A fastener according to claim 38 in which the intermediate region describes an involute curve.

40. A fastener according to claim 34 in which the second radius is at least two times the first radius.

41. A fastener according to claim 34 in which the second radius terminates at an end edge of the fastener head.

42. A fastener according to claim 34 in which the head comprises an end region between the second region and the end of the head opposite the shaft, the end region being curved oppositely to the first and second regions.

43. An aircraft assembly comprising:
a first panel having a first bore;
a second panel having a second bore aligned with the first bore;
in which at least one of the first and second panels is constructed from a composite material;
a fastener extending at least partially through the first and second bores to join the panels, the fastener comprising a shaft and a head, in which the head comprises:
a curved, concave cross section having:
a first region proximate the shaft, the first region having a first radius of curvature, and,
a second region on the opposite side of the first region to the shaft, the second region having a second radius of curvature,
in which the second radius of curvature is larger than the first radius of curvature.
